(19) United States
(12) Patent Application Publication
(10) Pub. No.: US 2006/0142935 A1
(43) Pub. Date: Jun. 29, 2006

(54) Providing a user with location-based information

(76) Inventor: Eric Jos Bert Koerber, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/539,030

(22) PCT Filed: Nov. 20, 2003
(86) PCT No.: PCT/IB03/05470

§ 371 Date: Jun. 15, 2005

(30) Foreign Application Priority Data
Dec. 20, 2002 (EP) 02080515.6

(51) Int. Cl. G01C 21/34

(52) U.S. Cl. 701/200; 701/208

(57) ABSTRACT

The invention relates to a system for providing a user (100) with location-based information, the system comprising a user device (110) arranged to enable the user to use the location-based information, the user device being arranged to enable the user to point the user device (110) substantially at a remote physical location (130, 140) for selecting information corresponding to said remote location. The user device may be arranged to identify said remote location of the device (130, 140) by identifying current location (120) of the device and a direction at which the user device is substantially pointed. The invention also relates to a method of providing a user with location-based information.

The invention relates to a system for providing a user with location-based information. The invention also relates to a method of providing a user with location-based information.

Document U.S. Pat. No. 6,327,535 discloses a system utilizing hierarchical tree structures to ascertain a device location. The tree structures that identify geographical divisions and/or physical or logical entities are defined. Goods or services can be associated with individual nodes on the tree, the nodes providing a reference when attempting to locate the goods or services. Location providers provide hints about a current location of the device, and the device can turn the hints into a nodal location of the tree structure. A complete device location can be ascertained by using the tree structures. Whenever the current device location is determined, it can take advantage of location-dependant goods or services corresponding to the determined location.

In another approach, location beacons transmitting information that can be used to directly ascertain the device location are also described. The beacon provided by the location information provider can be located in various places such as public or private places to transmit information about the current device location within the defined hierarchical infrastructure. Examples of location providers are Global Positioning Service (GPS) providers, cell phone providers, Bluetooth providers. In addition, the beacon can transmit code download pointers enabling the device to access a software code.

In the prior art, to use services, goods or some information of some location, the user has to reach that location beforehand. In some cases, for example, when the user enters a crowded area such as a mall, airport, exhibition hall, etc, it may be burdensome for the user to travel from one place to another. It may take the user a lot of time.

It is an object of the present invention to obviate the drawbacks of the prior art and to provide a system for providing the user with location-based information, in which the use with his device does not have to change his location in order to use information of a particular location.

The object of the invention is realized in that the system comprising a user device is arranged to enable the user to use the location-based information, the user device being arranged to enable the user to point the user device substantially at a remote physical location for selecting information corresponding to said remote location.

If the user would like to access information which is not associated with the current location but with the remote physical location, the user may simply “instruct” his device to get the information corresponding to that remote location. This can be done by pointing the user device at the remote location or remote locations whose information the user would like to use, e.g. to browse electronic documents showing goods of another shop, or to read the web-page of a movie theater with its agenda, etc. The user device identifies the remote location and selects the information corresponding to that remote location, and the user can use the desired selected information without changing his current location. The user may need to specify, e.g. by pointing, only approximately at the remote location. More than one remote location may be identified in a direction pointed by the user. In that case, the user may further specify which location he exactly desired to select. Alternatively, the user may prefer to use the information from many remote locations, probably also the information of the current location, at the same time. When the information of the desired remote location is obtained by the device, the user device presents said information to the user using its own presentation means, such as a display screen, speakers, etc, or using presentation facilities of the environment in which the user is currently present.

The object of the invention is also realized in that the method of providing a user with location-based information comprises the steps of:

using a user device arranged to enable the user to use the location-based information, and

pointing the user device substantially at a remote physical location for selecting information corresponding to said remote location.

The method describes the operation of the system of the present invention.

These and other aspects of the invention will be further elucidated and described with reference to the accompanying drawings, wherein:

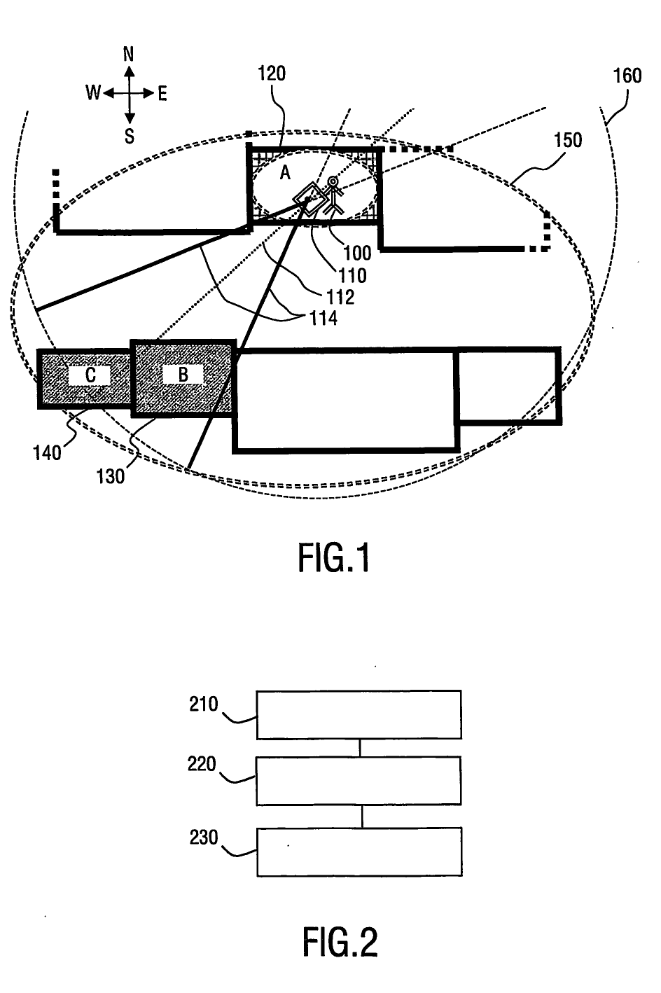

FIG. 1 shows a diagram illustrating operation of the system suitable for implementing the-present invention;

FIG. 2 shows an embodiment of the method according to the present invention.

FIG. 1 shows a user 100 and a device 110 arranged to enable the user 100 to use location-based information. The usage of the location-based information may, for example, lie in presenting content such as audio, video or textual information to the user, while the user can use the device to browse Internet information such as HTML pages or other electronic documents, the device can execute computer programs, i.e. software applications, and the user can interact with a location-dependent user interface, etc.

FIG. 1 depicts, just as an example, a mall plan with different shops and premises. In the example, the user device 110 is present at a location “A” 120, which may be, for instance, a shop. The system may be arranged in such a way that each shop may provide its price-list to the customers, i.e. the users, in an electronic form. If the user device is located in the premises of the shop, the device may try to access that price-list and display it to the user. This may be advantageous, for example, in the large-area shops. The price-list is just an example of the location-based information therein. In another example, the shop may provide to the customers some advertisement or information about its latest products, etc.

Being in the location “A” of the shop, the user may wish to read the price-lists of other shops, a location “B” 130 and/or a location “C” 140, because, for example, he would like to compare the price of some product(s) in different shops.

According to the present invention, the user may point the device 110 substantially at the remote locations 130 and/or 140 to select information, e.g. the price-list, corresponding to said location(s). The invention is not restricted to “pointing” the device 110. Alternatively, the user may indicate the direction in which the desired location is located by providing some input to the device, such as by typing a text “next shop to the left”, or “a next shop to the left of the current shop, the other shop is on an opposite side of the street”, etc. In this example, an implicit “direction” to the desired location may be indicated.

The remote location whose information the user would like to use may be identified. There are different manners of identifying the remote location. For example, the location may be directly identified when the remote location is provided with some transponder unit, e.g. a beacon, arranged to transmit the location identification data to the device 110 in response to the reception from the device 110 of a request for an identification of the location.

In another approach, a current location of the device and the direction from the current location of the device to the remote location may need to be identified.

Identification of the current location may be done in various ways. For example, the device 110 may be arranged to obtain GPS coordinates of the device, in this case the determination of the device current location may be fairly precise.

In another example, an area in which the device is currently present may be identified. In this case, the current location may be determined not very accurately but sufficiently for the present invention. In turn, the area of the current location of the device 120 may be the premises of the shop, e.g. a location 120, or a territory of the whole mall 150. The user may facilitate the identification of the current position by providing some information such as a name of the street or name of the city district, etc. The device may automatically identify the current location by acquiring and analyzing information about the environment in which it is located. For example, the device may comprise a video camera arranged to capture images with signs and logos of the shops. The signs may be recognized using well-known text recognition techniques. The device may be arranged to determine a name of the office or shop, address, etc associated with the logos using different information sources and analyzing various databases.

A navigation database which may be remotely accessible or incorporated into the device may be used for determination of the current location, e.g. for determining location identification data corresponding to a particular location. The location identification data may include a name of the location as an administrative unit such as the name of the shop, a postcode, city, etc., name of the geographical area, or other data such as a nickname, URL of the Internet document, etc.

Hierarchical tree structures may be used to determine the current location of the device as described in U.S. Pat. No. 6,327,535.

In FIG. 1, the user uses the device 110 to point at the locations 130 and 140. The device may comprise pointing means. The pointing means may be used for relatively exact pointing, a line 112, or for pointing at locations within some range or angle, for example the angle between lines 114, which may be any angle by means of which the user can sufficiently exactly specify the desired location or locations. The pointing means may be arranged to adjust its pointing angle. The range-pointing 114 may be expressed as specifying the direction with a certain accuracy, wherein the accuracy depends on the range captured with the direction line 112. The accuracy may be higher if the angle of pointing is smaller. Basically, the direction 112 to the remote location may be expressed by measuring an angle between the direction line 112 and North, South, West or East. Many methods for determining an orientation of the device, for example using an electronic compass, are well known in geodesy. In another example, said angle of the line 112 with respect to other references, such as a direction of the magnetic field, etc may be measured. The range-pointing 114 may be expressed, for example, by specifying an angle of bisector. The pointing means may be arranged to determine and adjust a distance 160 within which the user may specify the remote location to be identified.

The navigation database may be arranged to store the location identification data associated with the particular physical location. The location identification data may describe a position of one location with respect to another location, e.g. a virual map of the locations. A size, form, e.g. a shape, of the area of the location may also be characterized in the location identification data. When the current position of the device 110 and the direction of pointing 112 or 114 are determined, the device 110 may identify the remote location that is pointed at. The navigation database may be used for said identification. Thus, the identification of the remote location may be performed fully automatically upon pointing at that remote location. The identification of the-remote locations 130 and 140 which are pointed at, for example, as shown in FIG. 1, does not present difficulties, and the device performing such an identification may be realized by the person skilled in the art. For example, elements of geometry may be used to perform calculations necessary for such identification.

Other manners of identifying the remote locations depending on the accuracy of identification and/or amount of information about the current location and/or direction to the remote location may be envisaged.

The user device may be arranged to identify a plurality of the remote locations, such as, for example, the locations 130 and 140 which are in the pointing range 114 at the same time. As FIG. 1 shows, lines 114 intersect edges of two other remote locations, one location is next to the location “A” 120 and another location is next to the location “B” 130. The user device may be arranged to ignore such intersections and identify the remote locations which the device is substantially pointed at. If more than one remote location is identified, the user device may be arranged to notify the user about it. The notification may also be performed by the user device when only one remote location is identified because this may give the user confidence that the actually desired location is identified.

The notification about the identified remote locations may be done in various ways. For example, the user device maybe arranged to retrieve an electronic map of the remote locations from the navigation database. Thus, the user may, for example, take a look on the remote physical locations if it is possible, and visually compare which remote locations on the map correspond to the physical locations. Such a manner of notification may be conveniently realized when the user device has a small display screen, for example, when the user device is a mobile phone.

In another example, the notification may be effected in that the device 1120 may be arranged to present a list of the identified remote locations to the user. The locations in the list, i.e. list items, may be designated using the names of the locations, such as the names of the shops retrieved from the navigation database, the logo of the identified location, at least part of the information corresponding to the respective identified remote location, such as the introductory part displayed to the user upon execution of the software application associated with the particular remote location, etc.

The device 110 may be arranged to provide the user with selection means arranged to select one of the identified remote locations whose information is to be further obtained. Thus, the user may select one of the plurality of the identified remote locations in response to the notification described above. The selection means may be realized with any suitably arranged input means such as a pointing means, keyboard or trackball.

Alternatively, the device may be arranged to obtain the information corresponding to each identified remote location. For example, the display screen of the device may be shared by two or more user interfaces corresponding to the different identified remote locations.

In one of the embodiments of the present invention, the notification of the user about the identified remote locations may not be necessary. For example, the remote locations are intersected by the bisector 112 one after another, the user may simply pre-select that the second intersected remote location is the desired or preferred location, the location-based information of which is to be used by the user.

The device may enable the user to select the number of remote locations to traverse, and select the remote location of interest. For example, if there are ten neighboring remote locations and the user wants to select the fifth traversed remote location, he may point in the direction(s) of the ten regions. Those remote locations may, for example, each lie behind each other (not shown in FIG. 1). Then, the user may simply press a respective button of the selection means.

The user device 110 may be further arranged to verify whether any information corresponds to the identified location(s). An information database storing location information data pertaining to the information corresponding to the particular location may be used for such a verification.

For the particular remote location, the device 110 may query the navigation database to retrieve the corresponding location identification data The retrieved location identification data may comprise the name, nickname or other identifier of the remote location as described above. The user device may be further arranged to use said location identification data to query the information database so as to retrieve the location information data corresponding to the respective remote location.

Generally, the navigation database and the information database may be arranged to store some kind of an identifier unambiguously associated with the respective physical location. Such identifiers may be used to ensure that the user device can retrieve from the information database the location information data corresponding to the same remote location that was identified using the navigation database. The location identification data in the navigation database may comprise such identifiers for the respective locations.

The user device may be further arranged to obtain the information corresponding to the remote location using the location information data. The location information data may comprise only data, e.g. pointers, indicating at least one information storage storing the information corresponding to the remote location. Alternatively, the information database itself may be arranged to store the information corresponding to the remote location. The information corresponding to the remote location may comprise an application to be executed by a computer, data pertaining to a location-based user interface, content information such as electronic documents, etc. The user device may be arranged to accommodate the navigation database and/or the information database. Alternatively, the user device may comprise a communication module arranged to remotely access, e.g. to download, data from the navigation database and/or the information database.

It may occur that no information pertaining to the remote location is stored in the information database. In that case, the user device may be arranged to search for said information using other data storage such as the Internet or other information sources which are remotely accessible. The user device may be arranged to notify the user that no information corresponding to the particular remote location can be found.

The user device 110, as a client device, may be arranged to communicate with a remote server. The remote server may be arranged to store and maintain said navigation and/or information database. The server may be arranged to receive and process data queries from the user device, and transmit results of processing the queries to the user device. The server may be arranged to execute the location-based software applications, for example, for providing location-based services to the user of the device 110.

The user device may incorporate a data-processing system having a microprocessor coupled to a random access memory and read-only memory arranged to store computer program to be executed by said microprocessor. The user device may incorporate the pointing means and the communication module suitable for receiving and/or transmitting data by means of an electrical conductor or optical fibers or in a wireless manner. The user device may comprise an output means suitable for presenting to the user the obtained location-based information such as display screen and/or speakers, and input means suitable for providing the user input to the user device such as a keyboard, mouse, joystick, touch-pad, etc. Given the examples and explanations above, a technical implementation of the present invention, and particularly of the user device, will be apparent to the skilled person.

FIG. 2 shows an embodiment of the method of providing the user with location-based information according to the present invention. The method comprises a step 210 of using the user device arranged to enable the user to use the location-based information. The wording “use of the user device” and “use of the location-based information” has already been explained with reference to the system of the present invention.

The method also comprises a step 220 of pointing the user device substantially at a remote physical location for selecting information corresponding to said remote location. For example, being on a market square, the user may point his device at a direction of the shop at the other side of the square, thereby traversing all regions of the terraces belonging to cafes. In step 230, the user device may be arranged to show him information from that shop, such as a list of products with discounts. In this case, the use of the information may be the visual presentation of the information to the user for browsing. Different embodiments of the method may be derived from the operation of the system according to the present invention described above.

The various program products may implement the functions of the device and method of the present invention and may be combined in several ways with the hardware or located in different other devices. Variations and modifications of the described embodiment are possible within the scope of the inventive concept. Thus, for example, the use of the verb ‘to comprise’ and its conjugations does not exclude the presence of elements or steps other than those defined in a claim. The invention can be implemented by means of hardware comprising several distinct elements, and by means of a suitably programmed computer. In the device claim enumerating several means, several of these means can be embodied by one and the same item of hardware.

1. A system for providing a user (100) with location-based information, the system comprising a user device (110) arranged to enable the user to use the location-based information,
the user device being arranged to enable the user to point the user device (110) substantially at a remote physical location (130, 140) for selecting information corresponding to said remote location.

2. The system of claim 1, further comprising a navigation database storing at least one location identification data associated with a particular physical location.

3. The system of claim 1, wherein the user device is arranged to identify a direction at which the user device is substantially pointed.

4. The system of claim 3, wherein the user device is arranged to identify a current location (120) and/or said remote location of the device (130, 140).

5. The system of claim 4, wherein the user device is arranged to verify whether any information corresponds to the identified location.

6. The system of claim 4, wherein the user device is arranged to identify a plurality of the remote physical locations (130, 140) at which the user device is pointed, and
wherein the user device is arranged to notify the user that more than one remote physical location at which the user device is pointed has been identified, and
wherein the user device is further arranged to invite the user to select one of the identified physical locations.

7. The system of claim 4, wherein the user device is further arranged to present to the user a visual representation associated with at least one identified remote physical location.

8. The system of claim 1, wherein said information is one of:
a location-based software application, or
a location-based user interface, or
content information.

9. The system of claim 8, wherein said application is to be executed at a remote server, and wherein the user device is a client device for said server.

10. The system of claim 1, further comprising an information database storing location information data pertaining to the information corresponding to a particular physical location.

11. The system of claim 2, wherein the user device is arranged to
query the navigation database to determine the location identification data associated with the particular physical location, and
use the determined location identification data to query the information database to retrieve the location information data corresponding to the physical location, and
obtain the information corresponding to the particular physical location, using the retrieved location information data.

12. The system of claim 10, wherein said location information data are data only indicating at least one information storage storing information for the particular location.

13. The system of claim 2, wherein the user device is arranged to accommodate the navigation database and/or the information database.

14. The system of claim 2, wherein the user device is arranged to remotely access the navigation database and/or the information database.

15. A method of providing a user with location-based information, the method comprising the steps of:
using (210) a user device arranged to enable the user to use the location-based information, and
pointing (220) the user device substantially at a remote physical location for selecting information corresponding to said remote location.

16. A computer program product enabling a programmable device, when executing said computer program product, to function as the system as defined in claim 1.
